(19) United States
(12) Patent Application Publication
(10) Pub. No.: US 2024/0191621 A1
(43) Pub. Date: Jun. 13, 2024

(54) METHOD AND SYSTEM FOR DETERMINING HIGH PERMEABILITY ZONES WITHIN A RESERVOIR USING WEATHERING INDEX DATA

(71) Applicant: SAUDI ARABIAN OIL COMPANY, Dhahran (SA)

(72) Inventors: Saugata Dass, Dhahran (SA); Kausik Saikia, Dhahran (SA); Ahmed S. Garwan, Dhahran (SA); Neil W. Craigie, Dhahran (SA)

(73) Assignee: SAUDI ARABIAN OIL COMPANY, Dhahran (SA)

(21) Appl. No.: 18/079,662

(22) Filed: Dec. 12, 2022

(51) Int. Cl. E21B 49/00; E21B 43/14; E21B 43/26; E21B 44/00; E21B 49/02

(52) U.S. Cl. CPC E21B 49/005; E21B 43/14; E21B 43/26; E21B 44/00; E21B 49/02; G01N 23/223

(57) ABSTRACT

A method may include obtaining geological data for a geological region of interest. The geological data may include aluminum (Al) data. The method may further include determining weathering index data for the geological region of interest using the geological data. The weathering index data may describe alterations of detrital minerals to authigenic clay minerals. The method may further include determining various hydrocarbon zones in the geological region of interest using the weathering index data. The method may further include determining a well path in the geological region of interest based on the hydrocarbon zones. The method may further include transmitting a command to a drilling system or a stimulation control system.

### BACKGROUND

Deep seated clastic reservoirs may be tighter because of diagenesis that results in the breakdown of minerals to produce clays. These clays may precipitate in pore throats, resulting in clogging and hence destroying permeability of rocks. As such, identification of zones of low clay precipitation may help place wells, select testing intervals, and determine stimulation operations to enhance permeability to increase hydrocarbon production.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In general, in one aspect, embodiments relate to a method that includes obtaining geological data for a geological region of interest. The geological data includes aluminum (Al) data. The method further includes determining, by a computer processor, weathering index data for the geological region of interest using the geological data. The weathering index data describes alterations of detrital minerals to authigenic clay minerals. The method further includes determining, by the computer processor, various hydrocarbon zones in the geological region of interest using the weathering index data. The method further includes determining, by the computer processor, a well path in the geological region of interest based on the hydrocarbon zones. The method further includes transmitting, by the computer processor, a command to a drilling system based on the well path.

In general, in one aspect, embodiments relate to a system that includes a stimulation control system coupled to a wellbore. The system further includes a reservoir simulator coupled to the stimulation control system. The reservoir simulator includes a computer processor. The reservoir simulator performs a method that includes obtaining geological data for a geological region of interest. The geological data includes aluminum (Al) data. The method further includes determining weathering index data for the geological region of interest using the geological data. The weathering index data describes alterations of detrital minerals to authigenic clay minerals. The method further includes determining various stimulation parameters based on the weathering index data. The stimulation control system performs a hydraulic stimulation operation based on the stimulation parameters.

In general, in one aspect, embodiments relate to a system that includes a drilling system including various sensors and a drill string that includes a drill bit. The drilling system is coupled to a wellbore. The system further includes a reservoir simulator coupled to the drilling system. The reservoir simulator includes a computer processor. The reservoir simulator performs a method that includes obtaining geological data for a geological region of interest. The geological data includes aluminum (Al) data. The method further includes determining weathering index data for the geological region of interest using the geological data. The weathering index data describes alterations of detrital minerals to authigenic clay minerals. The method further includes determining various hydrocarbon zones in the geological region of interest using the weathering index data. The method further includes determining a well path in the geological region of interest based on the hydrocarbon zones. The drilling system performs a drilling operation for a well path based on the hydrocarbon zones.

In some embodiments, a sweet spot is determined within a geological region of interest using weathering index data. One or more stimulation parameters may be determined for a stimulation operation at the sweet spot using the weathering index data. and a command may be transmitted to a stimulation control system, where the command causes the stimulation operation to be performed based on the one or more stimulation parameters. In some embodiments, various elemental logs are determined from one or more wellbores using various cuttings and an X-ray fluorescence (XRF) spectrometer. A portion of geological data may be based on the elemental logs. In some embodiments, effective porosity data of various regions are determined in the geological region of interest. Various hydrocarbon zones may be determined using the effective porosity data and the weathering index data. In some embodiments, geological data includes magnesium (Mg) data, calcium data (Ca), potassium (K) data, and sodium (Na) data. Weathering index data may be based on an elemental ratio of aluminum to a sum of magnesium, calcium, potassium, and sodium at a predetermined depth interval. In some embodiments, weathering index data describes changes of magnesium, potassium, and sodium with respect to aluminum among various grains in the geological region of interest. In some embodiments, a drilling operation is performed at a wellbore in a geological region of interest. The drilling operation may acquire various cuttings from drilling fluid circulated in the wellbore during the drilling operation. Cutting data may be determined from the cuttings. A portion of geological data may be based on the cutting data. In some embodiments, one or more core samples are acquired using a coring tool from a wellbore in a geological region of interest. Core sample data may be determined using the one or more core samples. A portion of geological data may be based on the core sample data.

In some embodiments, various well logs are obtained for various wells in a geological region of interest. A portion of geological data may be based on the well logs. In some embodiments, various hydrocarbon zones correspond to a first weathering index threshold, a second weathering index threshold, and a third weathering index threshold. The first weathering index threshold may correspond to a predetermined amount of permeability or hydrocarbon recoverable without a stimulation operation. The second weathering index threshold may correspond to a predetermined amount of hydrocarbon that is recoverable only with a stimulation operation. The third weathering index threshold may correspond to no amount of hydrocarbon recoverable with a stimulation operation. In some embodiments, various hydrocarbon zones include a first hydrocarbon zone and a second hydrocarbon zone. The first hydrocarbon zone may correspond to a first portion of the geological region of interest including a first permeability threshold, and the second hydrocarbon zone may correspond to a second permeability threshold that is different from the first permeability threshold. In some embodiments, a user device is coupled to a stimulation control system and/or a drilling system. The user device may provide a graphical user interface for presenting various stimulation parameters and/or drilling parameters based on weathering index data. In some embodiments, a logging system includes a coring tool where one or more core samples are acquired from a wellbore in the geological region of interest using the coring tool. A portion of geological data may be based on core sample data using the one or more core samples.

In light of the structure and functions described above, embodiments disclosed herein may include respective means adapted to carry out various steps and functions defined above in accordance with one or more aspects and any one of the embodiments of one or more aspect described herein.

Other aspects and advantages of the claimed subject matter will be apparent from the following description and the appended claims.

### BRIEF DESCRIPTION OF DRAWINGS

Specific embodiments of the disclosed technology will now be described in detail with reference to the accompanying figures. Like elements in the various figures are denoted by like reference numerals for consistency.

FIGS. 1, 2A, 2B, and 3 show systems in accordance with one or more embodiments.

FIG. 4 shows a flowchart in accordance with one or more embodiments.

FIGS. 5A, 5B, 5C, 5D, 5E, 5F, 5G, 5H, and 6 shows examples in accordance with one or more embodiments.

FIG. 7 shows a computer system in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before”, “after”, “single”, and other such terminology. Rather, the use of ordinal numbers is to distinguish between the elements. By way of an example, a first element is distinct from a second element, and the first element may encompass more than one element and succeed (or precede) the second element in an ordering of elements.

In general, embodiments of the disclosure include systems and methods for determining weathering index data for use in hydrocarbon exploration, drilling operations, and/or stimulation operations. Using geological data found in elemental composition logs, for example, various hydrocarbon zones may be identified using weathering index data. In some embodiments, hydrocarbon zones may be identified with predetermined levels of permeability (e.g., “high” permeability) to increase hydrocarbon production. Examples of hydrocarbon zones may include zones with hydrocarbon deposits that can be recovered without stimulation operations as well as zones with high clay content that results in pore throat choking and tightness of clastic reservoirs that can be avoided for well placement.

In some embodiments, for example, weathering index data may be based on elemental ratios of aluminum content to various alkaline elements such magnesium (Mg) and calcium, or alkali metals such as potassium (K) and sodium (Na). In particular, a weathering index may correspond to an index of alteration that indicates changes in mineral composition of parent rock in a gradual or abrupt way. In other words, these changes in elemental compositions may reflect continuous leaching of various elements from various chemical weathering processes. More specifically, such chemical alterations may occur with relatively unstable detrital minerals, such as feldspars and micas, to form clay minerals (e.g., illite, smectite, and kaolinite). As such, weathering index data may provide a good indicator for potential production wells to identify one or more sweet spots in the subsurface for hydrocarbon recovery. For future well planning, spatial distribution of weathering may be determined between the wells, such as using geo-cellular modelling of weathering index data and other interpolation processes.

Furthermore, traditional methods of characterizing tight sandstone reservoirs have been challenging since hydraulic fracturing operations are often needed in many cases. However, by selecting a hydrocarbon zone in a lateral well path with one or more sweet spots, well productivity may be increased, and stimulation operations may be eliminated or decreased accordingly. Thus, weathering index data may provide a valuable reservoir indicator on where to drill in a well path as well as whether any additional operations are required to exploit the production well. Thus, hydrocarbon deposit recovery may be increased while completion operations may also be mitigated for exploiting a respective reservoir.

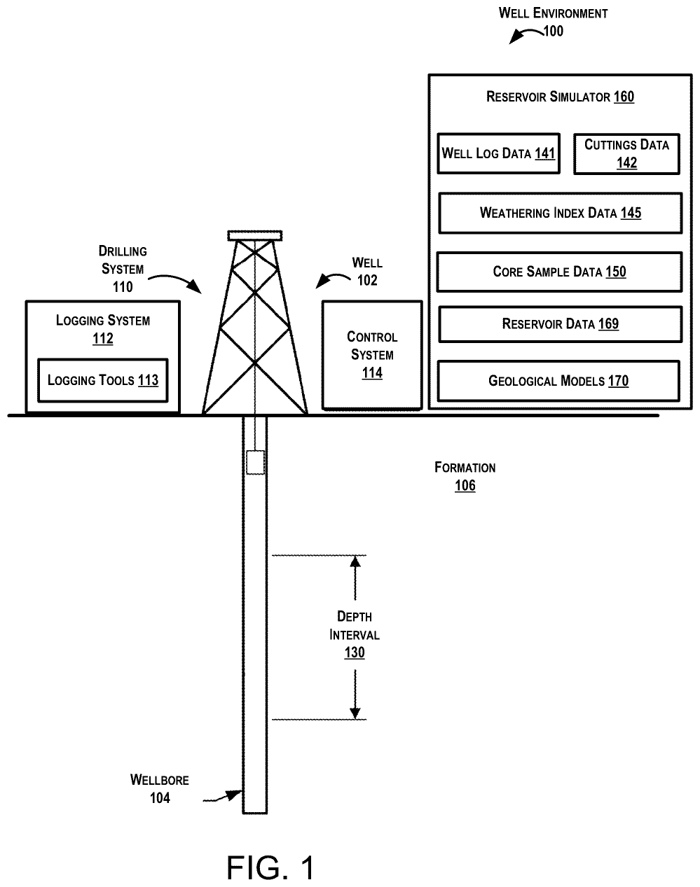

Turning to FIG. 1, FIG. 1 shows a schematic diagram in accordance with one or more embodiments. As shown, FIG. 1 illustrates a well environment (100) that may include a well (102) having a wellbore (104) extending into a formation (106). The wellbore (104) may include a bored hole that extends from the surface into a target zone of the formation (106), such as a reservoir. The formation (106) may include various formation characteristics of interest, such as formation porosity, formation permeability, resistivity, density, water saturation, and the like. Porosity may indicate how much space exists in a particular rock within an area of interest in the formation (106), where oil, gas, and/or water may be trapped. Permeability may indicate the ability of liquids and gases to flow through the rock within the area of interest. Resistivity may indicate how strongly rock and/or fluid within the formation (106) opposes the flow of electrical current. For example, resistivity may be indicative of the porosity of the formation (106) and the presence of hydrocarbons. More specifically, resistivity may be relatively low for a formation that has high porosity and a large amount of water, and resistivity may be relatively high for a formation that has low porosity or includes a large amount of hydrocarbons. Effective porosity may refer to that portion of the total void space of a porous material that is capable of transmitting a fluid. Effective permeability may refer to a state effective permeability as a function of a rock's absolute permeability. Water saturation may indicate the fraction of water in a given pore space.

Keeping with FIG. 1, the well environment (100) may include a reservoir simulator (160) and various well systems, such as a drilling system (110), a logging system (112), a control system (114), and a well completion system (not shown). The drilling system (110) may include a drill string, drill bit, a mud circulation system and/or the like for use in boring the wellbore (104) into the formation (106).

The control system (114) may include hardware and/or software for managing drilling operations and/or maintenance operations. For example, the control system (114) may include one or more programmable logic controllers (PLCs) that include hardware and/or software with functionality to control one or more processes performed by the drilling system (110). Specifically, a programmable logic controller may control valve states, fluid levels, pipe pressures, warning alarms, and/or pressure releases throughout a drilling rig. In particular, a programmable logic controller may be a ruggedized computer system with functionality to withstand vibrations, extreme temperatures, wet conditions, and/or dusty conditions, for example, around a drilling rig. Without loss of generality, the term “control system” may refer to a drilling operation control system that is used to operate and control the equipment, a data acquisition and monitoring system that is used to acquire equipment data and to monitor one or more well operations, or a well interpretation software system that is used to analyze and understand well events, such as drilling progress. A logging system may be similar to a control system with a specific focus on managing one or more logging tools.

Turning to the reservoir simulator (160), a reservoir simulator (160) may include hardware and/or software with functionality for storing and analyzing well log data (141), such as borehole image data, cutting data (142) from drilling cuttings acquired from drilling fluid circulating in a wellbore, hydraulic fracturing data, weathering index data (145), core sample data (150), seismic data, static wellbore data, reservoir data (169), such as porosity data and permeability data, and/or other types of data to generate and/or update one or more geological models (170), such as models for an unconventional reservoir. Borehole image data may be based on electrical and/or acoustic logging techniques, for example. Fracture image data may include outcrop images and other image types that include one or more fractures. Geological models may include geochemical or geomechanical models that describe structural relationships within a particular geological region. Cutting data may describe an analysis or rock typing performed on drill cuttings from a drilling operation, such as using visual methods of describing rock and pore characteristics. Hydraulic fracturing data may describe parameters of one or more hydraulic fracturing operations and associated acquired data, such as measurements relating to any induced fractures and any related results. Static wellbore data may describe well parameters relating to one or more wellbores, such as well locations, well types, and other well data. These different data types may be acquired during exploration, reservoir characterization, hydraulic fracturing, and production operations.

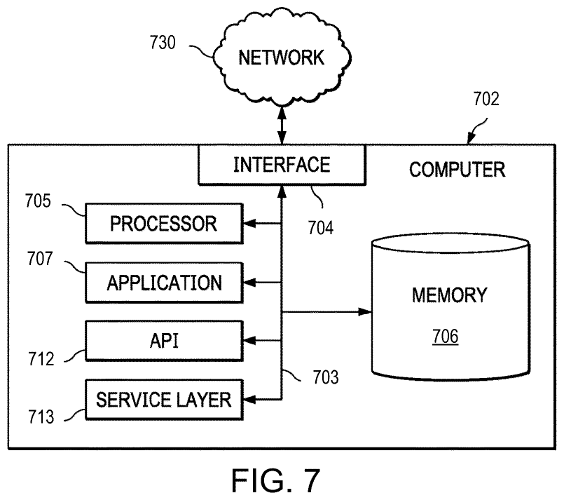

While the reservoir simulator (160) is shown at a well site, in some embodiments, the reservoir simulator (160) may be remote from a well site. In some embodiments, the reservoir simulator (160) is implemented as part of a software platform for the control system (114). The software platform may obtain data acquired by the drilling system (110) and logging system (112) as inputs, which may include multiple data types from multiple sources. The software platform may aggregate the data from these systems (110, 112) in real time for rapid analysis. In some embodiments, the control system (114), the logging system (112), the reservoir simulator (160), and/or a user device coupled to one of these systems may include a computer system that is similar to the computer system (702) described below with regard to FIG. 7 and the accompanying description.

The logging system (112) may include one or more logging tools (113) for use in generating well logs of the formation (106). For example, a logging tool may be lowered into the wellbore (104) to acquire measurements as the tool traverses a depth interval (130) (e.g., a targeted reservoir section) of the wellbore (104). The plot of the logging measurements versus depth may be referred to as a “log” or “well log”. Well log data (141) may provide depth measurements of the wellbore (104) that describe such reservoir characteristics as formation porosity, formation permeability, resistivity, water saturation, and the like. The resulting logging measurements may be stored and/or processed, for example, by the control system (114), to generate corresponding well logs for the well (102). A well log may include, for example, a plot of a logging response time versus true vertical depth (TVD) across the depth interval (130) of the wellbore (104).

Turning to examples of logging techniques, multiple types of logging techniques are available for determining various reservoir characteristics. In some embodiments, gamma ray logging is used to measure naturally occurring gamma radiation to characterize rock or sediment regions within a wellbore. In particular, different types of rock may emit different amounts and different spectra of natural gamma radiation. For example, gamma ray logs may distinguish between shales and sandstones/carbonate rocks because radioactive potassium may be common to shales. Likewise, the cation exchange capacity of clay within shales may also result in higher absorption of uranium and thorium further increasing the amount of gamma radiation produced by shales.

Turning to nuclear magnetic resonance (NMR) logging, an NMR logging tool may measure the induced magnetic moment of hydrogen nuclei (i.e., protons) contained within the fluid-filled pore space of porous media (e.g., reservoir rocks). Thus, NMR logs may measure the magnetic response of fluids present in the pore spaces of the reservoir rocks. In so doing, NMR logs may measure both porosity and permeability, as well as the types of fluids present in the pore spaces. Thus, NMR logging may be a subcategory of electromagnetic logging that responds to the presence of hydrogen protons rather than a rock matrix. Because hydrogen protons may occur primarily in pore fluids, NMR logging may directly or indirectly measure the volume, composition, viscosity, and distribution of pore fluids.

Turning to spontaneous potential (SP) logging, SP logging may determine the permeabilities of rocks in the formation (106) by measuring the amount of electrical current generated between drilling fluid produced by the drilling system (110) and formation water that is held in pore spaces of the reservoir rock. Porous sandstones with high permeabilities may generate more electricity than impermeable shales. Thus, SP logs may be used to identify sandstones from shales.

Another type of electrical logging technique is resistivity logging. Resistivity logging may measure the electrical resistivity of rock or sediment in and around the wellbore (104). In particular, resistivity measurements may determine what types of fluids are present in the formation (106) by measuring how effective these rocks are at conducting electricity. Because fresh water and oil are poor conductors of electricity, they have high resistivities. As such, resistivity measurements obtained via such logging can be used to determine corresponding reservoir water saturation (S_{w}).

Another electrical logging technique is dielectric logging. For example, dielectric permittivity may be defined as a physical quantity that describes the propagation of an electromagnetic field through a dielectric medium. As such, dielectric permittivity may describe a physical medium's ability to polarize in response to an electromagnetic field, and thus reduce the total electric field inside the physical medium. In a portion of reservoir rock, water may have a large dielectric permittivity that is higher than any associated rock or hydrocarbon fluids within the portion. In particular, water permittivity may depend on a frequency of an electromagnetic wave, water pressure, water temperature, and salinity of the reservoir rock mixture. Likewise, a multi-frequency dielectric logging tool may determine a value of the water-filled porosity in the reservoir rock.

Keeping with dielectric logging, a dielectric logging tool may determine a dielectric constant (i.e., relative-permittivity) measurement. For example, the dielectric logging tool may include an antenna that detects relative dielectric constants between different fluids at a fluid interface. As such, a dielectric logging tool may generate a dielectric log of the high-frequency dielectric properties of a formation. In particular, a dielectric log may include two curves, where one curve may describe the relative dielectric permittivity of the analyzed rock and the other curve may describe the resistivity of the analyzed rock. Relative dielectric permittivity may be used to distinguish hydrocarbons from water of differing salinities. However, the effect of salinity may be more important than the salinity effect with a high-frequency dielectric log (also called an “electromagnetic propagation log”).

Turning to sonic logging or acoustic logging, the logging system (112) may measure the speed that acoustic waves travel through rocks in the formation (106) to determine porosity in the formation (106). This type of logging may generate borehole compensated (BHC) logs, which are also called sonic logs. In general, sound waves may travel faster through high-density shales than through lower-density sandstones. Other types of logging include density logging and neutron logging. Density logging may determine porosity measurements by directly measuring the density of the rocks in the formation (106). Furthermore, neutron logging may determine porosity measurements by assuming that the reservoir pore spaces within the formation (106) are filled with either water or oil and then measuring the amount of hydrogen atoms (i.e., neutrons) in the pores.

Turning to coring, reservoir characteristics may be determined using core sample data (e.g., core sample data (150)) acquired from a well site. For example, certain reservoir characteristics can be determined via coring (e.g., physical extraction of rock specimens) to produce core specimens and/or logging operations (e.g., wireline logging, logging-while-drilling (LWD) and measurement-while-drilling (MWD)). Coring operations may include physically extracting a rock specimen from a region of interest within the wellbore (104) for detailed laboratory analysis. For example, when drilling an oil or gas well, a coring bit may cut core plugs (or “cores” or “core specimens”) from the formation (106) and bring the core plugs to the surface, and these core specimens may be analyzed at the surface (e.g., in a lab) to determine various characteristics of the formation (106) at the location where the specimen was obtained.

Turning to various coring technique examples, conventional coring may include collecting a cylindrical specimen of rock from the wellbore (104) using a core bit, a core barrel, and a core catcher. The core bit may have a hole in its center that allows the core bit to drill around a central cylinder of rock. Subsequently, the resulting core specimen may be acquired by the core bit and disposed inside the core barrel. More specifically, the core barrel may include a special storage chamber within a coring tool for holding the core specimen. Furthermore, the core catcher may provide a grip to the bottom of a core and, as tension is applied to the drill string, the rock under the core breaks away from the undrilled formation below coring tool. Thus, the core catcher may retain the core specimen to avoid the core specimen falling through the bottom of the drill string. In some embodiments, a micro computed tomography (micro-CT) scan is performed on a core sample. Several types of micro-CT scanning may be used, such as a desktop micro-CT scanner that uses an X-ray generation tube, and a synchrotron X-ray micro-tomography. In particular, a micro-CT scanner may use various X-rays to penetrate from different viewpoints in a core sample to produce an attenuated projection profile that is used for later reconstruction using a filtered back projection algorithm.

In some embodiments, cutting samples are acquired and analyzed from one or more drilling operations to determine various geological properties of one or more formations. In particular, cuttings may be initially cleaned in liquid detergent to remove drilling additives and before being dried on a ‘hotplate’. Dried cutting samples may be passed through one or more sieves to remove fragments of various sizes. Likewise, a magnet may be placed over a sieved cutting sample to remove any metallic fragments acquired during a drilling operation. After selecting various desired samples from the sieving and other preparation processes, selected samples may be ground into a fine powder for analysis using X-ray fluorescence (XRF) spectrometry processing and/or and inductively coupled plasma (ICP) spectrometry processing.

Turning to XRF spectrometry, XRF spectrometry may be performed using an XRF spectrometer. For example, an XRF spectrometer may be an x-ray instrument that is used for chemical analyses of rocks, minerals, sediments and fluids. In particular, the XRF spectrometer may use various wavelength-dispersive spectroscopic principles similar to the principles used by an electron probe microanalysis (EPMA). While an XRF spectrometer cannot generally perform chemical analyses at small spot sizes (e.g., 2-5 microns), an XRF spectrometer may be used for bulk analyses of larger samples of geological materials, such as for major chemical components and trace chemical elements in rocks, minerals, and sediment. Moreover, the analysis of major and trace elements in geological materials by X-ray fluorescence may be performed by analyzing the behavior of atoms interacting with radiation (e.g., high-energy short wavelength radiation, such as X-rays). When cutting samples or core samples are excited with X-rays, these geological samples may become ionized. If the transmitted radiation energy is sufficient to dislodge an inner electron, the atom may become unstable and an outer electron may replace the missing inner electron. Subsequently, energy may be released due to the decreased binding energy of the inner electron orbital compared with an outer one. The emitted radiation (i.e., fluorescent radiation) may thus be of lower energy than the primary incident X-rays. Because the energy of the emitted photon is characteristic of a transition between specific electron orbitals in a particular element, the resulting fluorescent X-rays may be used to determine elemental compositions in a cutting sample or core sample.

Turning to ICP spectrometry, ICP spectrometry may include inductively coupled plasma—optical emission spectrometry (ICP-OES) or inductively coupled plasma—mass spectrometry (ICP-MS). For example, ICP-OES and ICP-MS may be used to perform geochemical analyses to determine the presence of major elements (e.g., aluminum (Al), silicon (Si), titanium (Ti), iron (Fe), manganese (Mn), magnesium (Mg), calcium (Ca), sodium (Na), potassium (K), and phosphorus (P)), trace elements (e.g., barium (Ba), beryllium (Be), cobalt (Co), chromium (Cr), cesium (Cs), copper (Cu) etc.), and rare earth elements (REEs). Furthermore, ICP-OES processes may provide an analytical technique for determining the quantities of certain elements that are included in a core sample or a cutting sample. an ICP-OES process may use the principle that atoms and ions can absorb energy to move electrons from the ground state to an excited state, where the energy source is heat from an argon plasma that operates at 10,000 Kelvin. Thus, ICP-OES process may rely on various excited atoms releasing light at specific wavelengths to determine elemental compositions. Moreover, the amount of light released at each wavelength may be proportional to the number of atoms or ions making the transition.

Turning to ICP-MS processes, ICP-MS may include a type of mass spectrometry that uses an inductively coupled plasma to ionize a particular sample. For example, an ICP-MS process may atomize the sample to produce atomic and small polyatomic ions, that may be detected. As such, ICP-MS may be used for detecting metals and several non-metals in liquid samples at very low concentrations. Thus, an ICP-MS process may determine different isotopes of the same element, which may be used for isotopic labeling. Additionally, inductively coupled plasma processes may have two operation modes, i.e., a capacitive (E) mode with low plasma density and an inductive (H) mode with high plasma density.

Turning to chemical weathering, weathering index data may describe one or more chemical indexes of alteration (CIA) that may be used to assess the degree of chemical weathering in a geological region, e.g., to characterize the corresponding palaeoclimate. In particular, weathering index data may determine from the major element geochemistry of bulk sediment samples (e.g., core samples and cutting samples). For example, weathering index data may quantify the extent that various sediments have experienced chemical weathering. Likewise, weathering index data may provide an indication of the relative abundances of “unweathered” material and chemical weathering products. In other words, “unweathered” materials may include feldspars (e.g., which are common and may contain relatively mobile Ca, Na, and K constituent elements), while chemical weathered materials may include Al-rich clays. For illustration, a CIA of a sediment may increase as the extent of chemical weathering increases (e.g., from values of approximately 50 for “unweathered” feldspar-rich rocks to values near 100 for highly weathered, kaolinite- or gibbsite-rich sediments). In particular, CIA values for “average” shales may range from 70 to 75, such as those dominated by illite, where the CIA value for a sediment may also increase as grain size decreases. Likewise, trace element abundances may also serve as indicators of sediment provenance because trace elements are also relatively immobile during weathering.

Furthermore, weathering index data may be used to describe deep seated tight sandstone reservoirs. Sandstone reservoirs may have extensive hydrocarbon accumulation, while being characterized by low porosity and variable permeability due to compaction and various diagenetic processes through the geological time. In particular, diagenesis may refer to the physical and chemical processes occurring from the start of deposition continuing through compaction, cementation, and dissolution which impact reservoir quality heterogeneities, such as in a deep seated clastic reservoir. Reservoir petrography and geochemical analysis on deep seated tight sandstone formations have shown the reservoir includes quartz and feldspar as grains, cements that include quartz overgrowth, and clay minerals such as illite and kaolinite. In particular, weathering index data may correspond to various geochemical compositions that provide a foundation for hydrocarbon evaluations in terms of reservoir quality due to diagenetic process.

Keeping with FIG. 1, geosteering may be used to position the drill bit or drill string of the drilling system (110) relative to a boundary between different subsurface layers (e.g., overlying, underlying, and lateral layers of a pay zone) during drilling operations. In particular, geological model may be used by the drilling system (110) for steering the drill bit in the direction of desired hydrocarbon concentrations. In some embodiments, a well path of a wellbore (104) may be updated by the control system (114) using a geological model. For example, a control system (114) may communicate geosteering commands to the drilling system (110) based on well log data updates or predicted hydrocarbon data that are further adjusted by the reservoir simulator (160) using a geological model. As such, the control system (114) may generate one or more control signals for drilling equipment (or a logging system may generate for logging equipment) based on an updated well path design and/or an updated geological model. As such, a geosteering system may use various sensors located inside or adjacent to the drill string to determine different rock formations within a well path. In some geosteering systems, drilling tools may use resistivity or acoustic measurements to guide the drill bit during horizontal or lateral drilling.

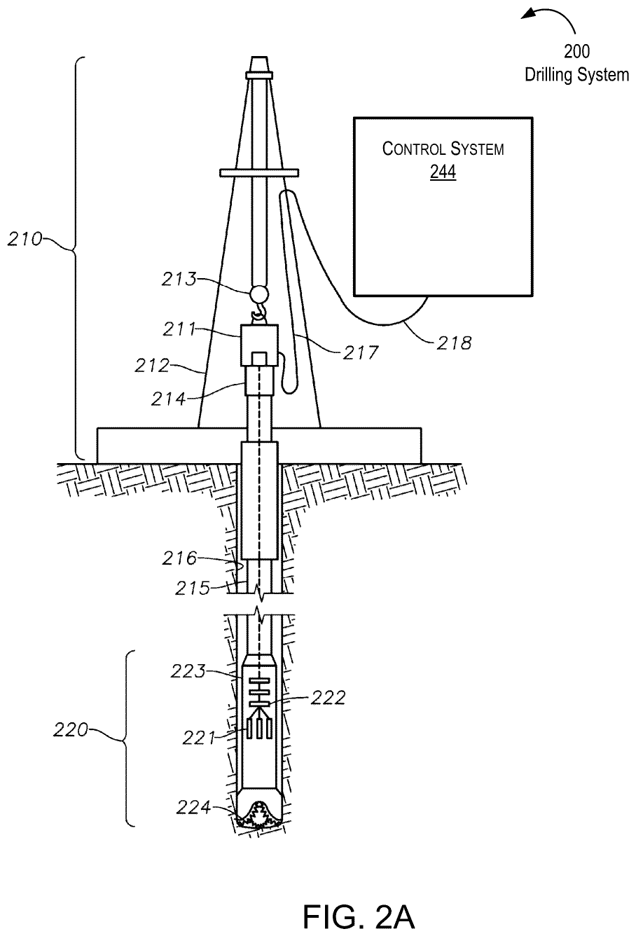

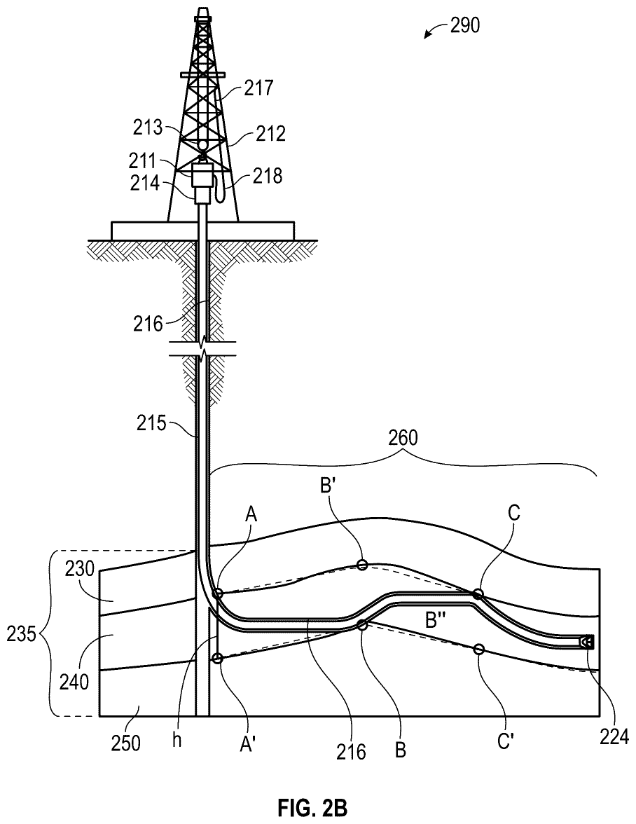

FIG. 2A illustrates a system in accordance with one or more embodiments. As shown in FIG. 2A, a drilling system (200) may include a top drive drill rig (210) arranged around the setup of a drill bit logging tool (220). A top drive drill rig (210) may include a top drive (211) that may be suspended in a derrick (212) by a travelling block (213). In the center of the top drive (211), a drive shaft (214) may be coupled to a top pipe of a drill string (215), for example, by threads. The top drive (211) may rotate the drive shaft (214), so that the drill string (215) and a drill bit logging tool (220) cut the rock at the bottom of a wellbore (216). A power cable (217) supplying electric power to the top drive (211) may be protected inside one or more service loops (218) coupled to a control system (244). As such, drilling fluid may be pumped into the wellbore (216) using the drive shaft (214) and/or the drill string (215). Likewise, the drilling system may also include a mud pump, a mud line, mud pits, a mud return, and other components related to the circulation or recirculation of drilling fluid within the wellbore (216). The control system (244) may be similar to various control systems described above in FIG. 1 and the accompanying description.

In some embodiments, the drilling system (200) includes a bottomhole assembly (BHA). The bottomhole assembly may refer to a lower portion of the drill string (215) that includes a drill bit (224), bit sub (i.e., a substitute adapter), and a drill collar. The bottomhole assembly may also include a mud motor, stabilizers, heavy-weight drillpipe, jarring devices (“jars”), crossovers for various threadforms, directional drilling and measuring equipment, measurements-while-drilling tools, logging-while-drilling tools and other specialized devices. The bottomhole assembly may produce force for the drill bit to break rock and provide the drilling system with directional control of a wellbore. Different types of bottomhole assemblies may be used, such as a rotary assembly, a fulcrum assembly, and a pendulum assembly.

Moreover, when completing a well, casing may be inserted into the wellbore (216). The sides of the wellbore (216) may require support, and thus the casing may be used for supporting the sides of the wellbore (216). As such, a space between the casing and the untreated sides of the wellbore (216) may be cemented to hold the casing in place. The cement may be forced through a lower end of the casing and into an annulus between the casing and a wall of the wellbore (216). More specifically, a cementing plug may be used for pushing the cement from the casing. For example, the cementing plug may be a rubber plug used to separate cement slurry from other fluids, reducing contamination and maintaining predictable slurry performance. A displacement fluid, such as water, or an appropriately weighted drilling fluid, may be pumped into the casing above the cementing plug. This displacement fluid may be pressurized fluid that serves to urge the cementing plug downward through the casing to extrude the cement from the casing outlet and back up into the annulus.

As further shown in FIG. 2A, sensors (221) may be included in a sensor assembly (223), which is positioned adjacent to a drill bit (224) and coupled to the drill string (215). Sensors (221) may also be coupled to a processor assembly that includes a processor, memory, and an analog-to-digital converter (222) for processing sensor measurements. For example, the sensors (221) may include acoustic sensors, such as accelerometers, measurement microphones, contact microphones, and hydrophones. Likewise, the sensors (221) may include other types of sensors, such as transmitters and receivers to measure resistivity, gamma ray detectors, etc. The sensors (221) may include hardware and/or software for generating different types of well logs (such as acoustic logs or density logs) that may provide well data about a wellbore, including porosity of wellbore sections, gas saturation, bed boundaries in a geologic formation, fractures in the wellbore or completion cement, and many other pieces of information about a formation. If such well data is acquired during drilling operations (i.e., logging-while-drilling), then the information may be used to make adjustments to drilling operations in real-time. Such adjustments may include rate of penetration (ROP), drilling direction, altering mud weight, and many others drilling parameters.

In some embodiments, acoustic sensors may be installed in a drilling fluid circulation system of a drilling system (200) to record acoustic drilling signals in real-time. Drilling acoustic signals may transmit through the drilling fluid to be recorded by the acoustic sensors located in the drilling fluid circulation system. The recorded drilling acoustic signals may be processed and analyzed to determine well data, such as lithological and petrophysical properties of the rock formation. This well data may be used in various applications, such as steering a drill bit using geosteering, casing shoe positioning, etc.

The control system (244) may be coupled to the sensor assembly (223) in order to perform various program functions for up-down steering and left-right steering of the drill bit (224) through the wellbore (216). More specifically, the control system (244) may include hardware and/or software with functionality for geosteering a drill bit through a formation in a lateral well using sensor signals, such as drilling acoustic signals or resistivity measurements. For example, the formation may be a reservoir region, such as a pay zone, bed rock, or cap rock.

Turning to geosteering, geosteering may be used to position the drill bit (224) or drill string (215) relative to a boundary between different subsurface layers (e.g., overlying, underlying, and lateral layers of a pay zone) during drilling operations. In particular, measuring rock properties during drilling may provide the drilling system (200) with the ability to steer the drill bit (224) in the direction of desired hydrocarbon concentrations. As such, a geosteering system may use various sensors located inside or adjacent to the drill string (215) to determine different rock formations within a well path. In some geosteering systems, drilling tools may use resistivity or acoustic measurements to guide the drill bit (224) during horizontal or lateral drilling.

Turning to FIG. 2B FIG. 2B illustrates some embodiments for steering a drill bit through a lateral pay zone using a geosteering system (290). As shown in FIG. 2B, the geosteering system (290) may include the drilling system (200) from FIG. 2A. In particular, the geosteering system (290) may include functionality for monitoring various sensor signatures (e.g., an acoustic signature from acoustic sensors) that gradually or suddenly change as a well path traverses a cap rock (230), a pay zone (240), and a bed rock (250). Because of the sudden change in lithology between the cap rock (230) and the pay zone (240), for example, a sensor signature of the pay zone (240) may be different from the sensor signature of the cap rock (230). When the drill bit (224) drills out of the pay zone (240) into the cap rock (230), a detected amplitude spectrum of a particular sensor type may change suddenly between the two distinct sensor signatures. In contrast, when drilling from the pay zone (240) downward into the bed rock (250), the detected amplitude spectrum may gradually change.

During the lateral drilling of the wellbore (216), preliminary upper and lower boundaries of a formation layer's thickness may be derived from a geophysical survey and/or an offset well obtained before drilling the wellbore (216). If a vertical section (235) of the well is drilled, the actual upper and lower boundaries of a formation layer (i.e., actual pay zone boundaries (A, A′)) and the pay zone thickness (i.e., A to A′) at the vertical section (235) may be determined. Based on this well data, an operator may steer the drill bit (224) through a lateral section (260) of the wellbore (216) in real time. In particular, a logging tool may monitor a detected sensor signature proximate the drill bit (224), where the detected sensor signature may continuously be compared against prior sensor signatures, e.g., of the cap rock (230), pay zone (240), and bed rock (250), respectively. As such, if the detected sensor signature of drilled rock is the same or similar to the sensor signature of the pay zone (240), the drill bit (224) may still be drilling in the pay zone (240). In this scenario, the drill bit (224) may be operated to continue drilling along its current path and at a predetermined distance (0.5h) from a boundary of a formation layer. If the detected sensor signature is same as or similar to the prior sensor signatures of the cap rock (230) or the bed rock (250), respectively, then the control system (244) may determine that the drill bit (224) is drilling out of the pay zone (240) and into the upper or lower boundary of the pay zone (240). At this point, the vertical position of the drill bit (224) at this lateral position within the wellbore (216) may be determined and the upper and lower boundaries of the pay zone (240) may be updated, (for example, positions B and C in FIG. 2B). In some embodiments, the vertical position at the opposite boundary may be estimated based on the predetermined thickness of the pay zone (240), such as positions B′ and C′.

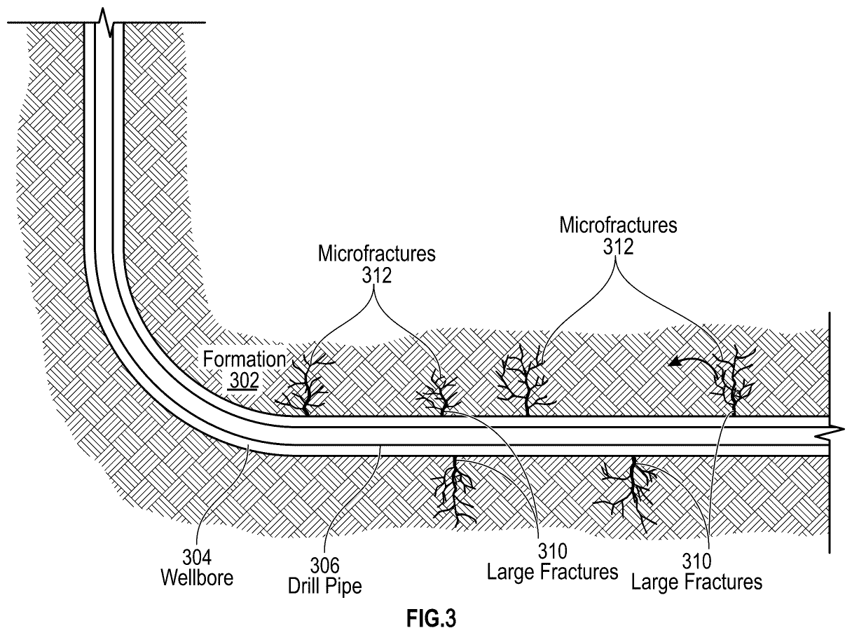

Turning to FIG. 3, FIG. 3 shows a schematic diagram in accordance with one or more embodiments. As shown in FIG. 3, FIG. 3 illustrates a hydraulic stimulation operation that forms additional microfractures (312) within a formation (302). More specifically, a wellbore (304) may be located within formation (302), where a casing string (306) is positioned within the wellbore (304). Following a hydraulic fracturing process, for example, large fractures (310) may exist within the formation (302) and extend outward from the wellbore (304). In particular, hydrocarbon reserves may be trapped within certain low permeability formations, such as sand, carbonate, and/or shale formations. Thus, stimulation treatments may be performed by a stimulation control system coupled to a well completion assembly or well completion system that enhances well productivity at one or more wells, where one type of stimulation treatment is hydraulic fracturing. In some embodiments, for example, hydraulic fracturing includes injecting high viscosity fluids into a wellbore at a sufficiently high injection rate so that enough pressure is produced within the wellbore to split the formation. As such, a stimulation operation may be determined that achieves a desired height and/or length of one or more induced fractures.

Keeping with FIG. 3, various stimulation procedures may be employed that use one or more techniques to ensure that an induced fracture becomes conductive after injection ceases. For example, during acid fracturing of carbonate formations, acid-based fluids may be injected into the formation to create an etched fracture and conductive channels. These conductive channels may be left open upon closure of the induced fracture. With sand or shale formations, a proppant may be included with the hydraulic fracturing fluid such that the induced fracture remains open during or following a stimulation treatment. Likewise, in carbonate formations, a stimulation treatment may include both acid fracturing fluids and proppants. Accordingly, heat produced within a formation, acid, or aqueous water transmitted into the formation may all play a role in producing reactions causing one or more microfractures in a formation.

Keeping with hydraulic fracturing, a hydraulic fracturing operation may include well completion assembly with one or more inflatable packers as well as a work string or casing string (306) that extends within a wellbore. A casing string may include steel casing or pipe that may be divided into surface casing, intermediate casing, and/or production casing. Packers may include inflatable packers that seal an annulus defined between well completion equipment and an inner wall of the wellbore in order to divide a formation into multiple wellbore intervals. These wellbore intervals may be separately or simultaneously stimulated during a hydraulic stimulation operation using a stimulation control system. Thus, in a hydraulic fracturing operation, a hydraulic fracturing fluid may be pumped through the casing string (306) and into a targeted formation using various perforations (i.e., open holes) in the casing string (306).

By injecting the hydraulic fracturing fluid at pressures high enough to cause the rock within the targeted formation to fracture, the hydraulic fracturing operation may “break down” the formation. As high-pressure fluid injection continues, a fracture may continue to propagate into a fracture network. This high pressure for injecting the hydraulic fracturing fluid may be referred to as the “propagation pressure” or “extension pressure.” As an induced fracture continues to grow, a proppant, such as sand, may be added to the fracturing fluid. Once a desired fracture network is formed, the fluid flow may be reversed and the liquid portion of the fracturing fluid is removed. The proppant is intentionally left behind to prevent the fractures from closing onto themselves due to the weight and stresses within the formation. Accordingly, the proppant may “prop” or support the induced fractures to remain open, by remaining sufficiently permeable for hydrocarbon fluids to flow through the induced fracture. Thus, a proppant may form a packed bed of particles with interstitial void space connectivity within a formation. Accordingly, a higher permeability fracture may result from the hydraulic fracturing operation.

In some embodiments, for example, a hydraulic fracturing fluid with an activator is injected into the formation (302), where the fluid migrates within the large fractures (310). Upon a reaction caused by the activator, the injection fluid may produce one or more gases and heat, thereby causing the microfractures (312) to be created within the formation (302). Thus, a stimulation treatment may provide pathways for the hydrocarbon deposits trapped within the formation (202) to migrate and be recovered by a production well. In other words, hydraulic stimulation operations may be applied to formations that easily fracture to produce more microfractures with little plastic deformation under compression.

Furthermore, fracture monitoring may be important to understanding and optimizing hydraulic fracturing treatments. For example, a hydraulic stimulation manager may perform diagnostics that determine various stimulation effects such as fracture geometry, proppant placement in one or more fractures, and/or fracture conductivity. This fracture monitoring may be performed using a distributed acoustic sensing (DAS) system implemented within a wellbore. In some embodiments, a DAS system includes various fiber-optic sensors (e.g., distributed over a single mode optical fiber several kilometers in length). As such, backscattered light may be measured and further analyzed using signal processing techniques to enable a DAS system to segregate an optical fiber into an array of individual acoustic receivers. More specifically, various pulses of light may be transmitted along the optical fiber, where characteristics of the backscattered light may change due to acoustic vibrations disturbing the casing of the optical fiber. Through DAS processing, the location of these disturbances may be identified.

Keeping with DAS systems, pumping operations may produce various acoustic signals along a wellbore and the adjacent fractures, where the acoustic sensing data depends upon geometrical and physical attributes of the propagating fractures. Accordingly, a quantitative DAS inversion may determine various fracture properties in hydraulic fracture monitoring. For example, a wellbore may be profiled in real time by removing DAS pump noise data and matching acquired data to a forward model regarding pulse propagation in the wellbore and adjacent fractures. Thus, DAS inversion may identify various hydraulic stimulation features such as tubing expansion, fluid-to-fluid interfaces, an adjacent hydraulic fracture, presence of a porous reservoir, and/or an annular compartment. During initial phases of a hydraulic stimulation operation, DAS inversion may determine location information of wireline logging equipment within a wellbore. For example, DAS techniques may verify whether perforating guns and packer-setting devices are disposed at desired depths in the wellbore. In some embodiments, DAS inversion is performed using additional data from distributed temperature sensors (DTS) and/or micro-seismic monitoring techniques.

In certain unconventional formations, for example, an important element that determines whether hydrocarbon recovery is economically viable is the presence of one or more sweet spots in the reservoir. A sweet spot may be generally defined herein as the area within a reservoir that represents the best production or potential for production. In a particular geological region, the sweet spot may be determined based on a lack of ductility, a destruction of internal cohesion, an ability for a rock to deform and fail with a low degree of inelastic behavior, and a rock's capability for self-sustaining fracturing. Likewise, sweet spots may include intervals within organic shales, which possess the highest relative hydrocarbon yield for drilling purposes.

Keeping with sweet spots, sweet spot identification may be used by a reservoir simulator to identify one or more drilling location for unconventional wells. In particular, a sweet spot may be determined with certain reservoir characteristics such as reservoir quality and completion quality based on predicted hydrocarbon data, reservoir data, well log data, seismic data, etc. As such, various technologies may be used to extract resources from unconventional reservoirs at certain sweet spots, such as hydraulic fracturing and horizontal wells.

With respect to proppant systems, a well completion system may include a proppant system. A proppant system may include transfer devices, such as chutes and conveyor belts, for transferring a propping agent (also called simply “proppant”) to a fluid mixing system. Likewise, a proppant system may include one or more proppant storage devices, such as a silo, and a housing. In particular, a silo may use fill ports for acquiring propping agents, which may be subsequently transferred to a fluid mixing system using drain valves and/or outlet ports. The proppant system may then dispense the propping agent to the fluid mixing system for producing a stimulation fluid.

Moreover, a stimulation treatment for a formation may be updated by a reservoir simulator using a geological model (e.g., one of the geological models (170)). For example, a reservoir simulator may use a geological model to perform one or more stimulation simulations using different injection fluid pressure rates, different types of proppants, acid-based treatments and non-acid treatments, etc., to determine a desired stimulation scenario for the formation.

Returning to FIG. 1, a reservoir simulator (160) may include hardware and/or software with functionality for generating and/or updating one or more geological models (170) for use in analyzing the formation (106). For example, the reservoir simulator (160) may store well logs and core sample data (150), and further analyze the well log data, the core sample data, seismic data, and/or other types of data to generate and/or update one or more geological models (170).

While FIGS. 1, 2A, 2B, and 3 show various configurations of components, other configurations may be used without departing from the scope of the disclosure. For example, various components in FIGS. 1, 2A, 2B, and 3 may be combined to create a single component. As another example, the functionality performed by a single component may be performed by two or more components.

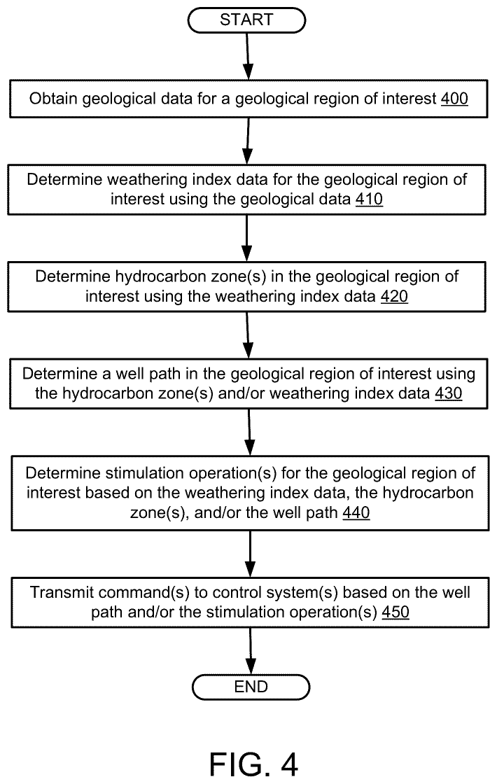

Turning to FIG. 4, FIG. 4 shows a flowchart in accordance with one or more embodiments. Specifically, FIG. 4 describes a general method for that uses weathering index data to determine hydrocarbon zones, such as for drilling and/or stimulation operations. One or more blocks in FIG. 4 may be performed by one or more components (e.g., reservoir simulator (160), control system (114), control system (244)) as described in FIGS. 1, 2A, 2B, and 3. While the various blocks in FIG. 4 are presented and described sequentially, one of ordinary skill in the art will appreciate that some or all of the blocks may be executed in different orders, may be combined or omitted, and some or all of the blocks may be executed in parallel. Furthermore, the blocks may be performed actively or passively.

In Block 400, geological data are obtained for a geological region of interest in accordance with one or more embodiments. In particular, geological data may include elemental composition data regarding one or more regions in the subsurface. For example, geological data may include aluminum data, magnesium data, calcium data, potassium data, sodium data, etc. In some embodiments, geological data includes elemental composition logs for one or more depth intervals in a wellbore. Likewise, geological data may also include permeability data, porosity data, reservoir flow data, and similar data such as effective porosity data or effective permeability data. Furthermore, a geological region of interest may be a portion of a geological area or volume that includes one or more wells or formations of interest desired or selected for further analysis, e.g., for determining a location of hydrocarbons or reservoir development purposes for a respective reservoir. As such, a geological region of interest may include one or more reservoir regions in an unconventional reservoir selected for running simulations.

Geological data may be acquired using well logging tools, coring techniques, cutting samples, and other techniques for acquiring geological data on one or more formations in a reservoir. Likewise, geological data may also include geological property information derived from well logs, core samples, and other data sources, such as permeability data, porosity data, and fracture data. In some embodiments, geological data is acquired from core samples and/or cutting samples using an X-ray fluorescence (XRF) spectrometer and/or an inductively coupled plasma (ICP) spectrometer as described above in FIG. 1 and the accompanying description. Moreover, the geological data may be obtained in real time from cutting samples (e.g., from cuttings acquired during a drilling operation).

In Block 410, weathering index data are determined for a geological region of interest using geological data in accordance with one or more embodiments. For example, a geochemical analysis may be performed on geological data to determine variable alterations of mineral, resulting in generation of clay. As such, geological data may be used to determine how chemical weathering has affected permeability by choking pore throats in the geological region of interest. In some embodiments, weathering index data may be based on one or more elemental ratios that describe the degree of clay precipitation in one or more geological regions. As such, various elemental ratios may be used to determine weathering index data. Moreover, weathering index data along one or more wells may be used to interpolate and/or extrapolate weathering index data along a particular spatial distribution within the geological region of interest. In some embodiments, weathering index data is determined using the following equation:

$$WI = \frac{Al}{( M g + C a + K + N a )} \qquad Equation 1$$

where WI is a particular weathering index that relates to various levels of alteration of detrital minerals to authigenic clay minerals.

In Block 420, one or more hydrocarbon zones are determined in a geological region of interest using weathering index data in accordance with one or more embodiments. Weathering index data may be used in conjunction with porosity data (e.g., effective porosity data) and permeability data to identify hydrocarbon zones enriched in clay minerals and thus high permeability values. For example, the flow of gas in a reservoir may be inhibited by pore throat sizes affected by chemical weathering that reduce permeability in various geological regions. As such, weathering index data may identify various zones in a reservoir that have desirability permeability (e.g., according to one or more permeability thresholds) for hydrocarbon exploration and reservoir development. Likewise, weathering index data may identify a hydrocarbon zone with commercially recoverable hydrocarbon based on one or more stimulation operations, such as a hydraulic fracturing operation. Characterizing layers with good reservoir properties may be a prerequisite in order to place well that provides production without stimulation.

Furthermore, a reservoir simulator may use weathering index data to determine various relationships between conventional reservoir properties (e.g., porosity and permeability) and the corresponding weathering index value. For example, these relations may be used to determine various hydrocarbon zones, such as by identifying sweet spots with different flow characteristics from other geological regions. More specifically, a porosity-permeability relation may depend on the architecture of pore throat, which varies with the accumulation of authigenic clay that results from the chemical weathering of minerals. Thus, identification of weathering intensity in rocks may be used to segregate regions of good and bad reservoir fluid flow in a geological region of interest. These regions of good reservoir fluid flow may be desirable well locations for future hydrocarbon production.

In some embodiments, hydrocarbon zones are determined using various weathering index thresholds among different weathering index values. For example, weathering index thresholds may be used in a geochemical evaluation to identify different categories of zones (such as sweet spots and non-reservoir regions without commercially recoverable hydrocarbon deposits) within the geological region of interest. In some embodiments, for example, elemental ratio values may indicate whether a hydrocarbon zone includes clean permeable sandstone. A corresponding weathering index threshold for clean permeable sandstone may be defined with an elemental ratio that is less than one. Likewise, another weathering index threshold may define a hydrocarbon zone that requires a stimulation operation for a predetermined hydrocarbon recovery as being more than 1 but less than 2.5. Moreover, another weathering index threshold may define a zone with poor interconnectivity within the geological region as having a weathering index value more than 2.5.

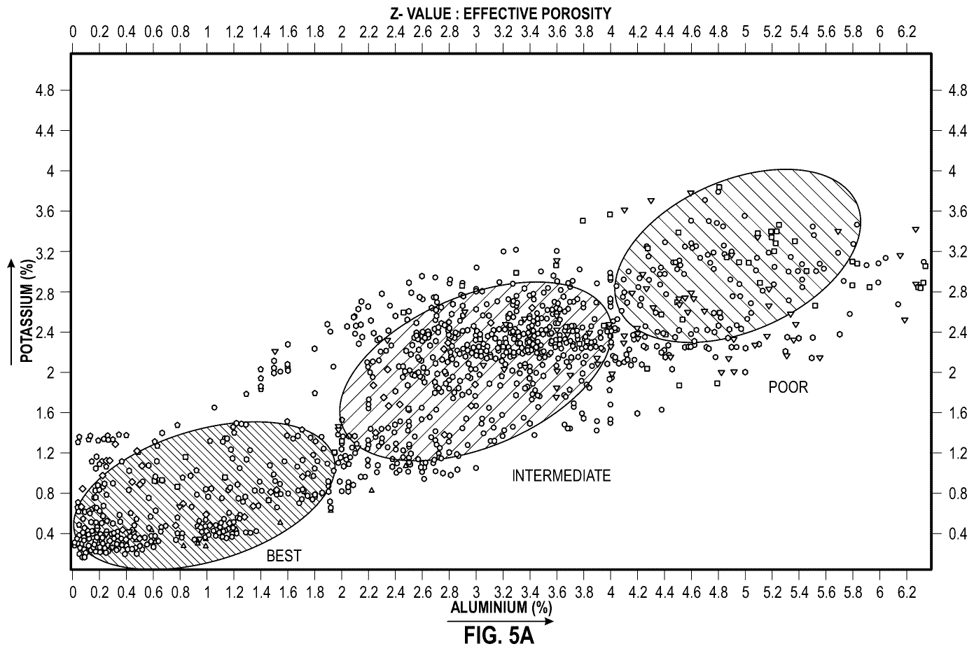

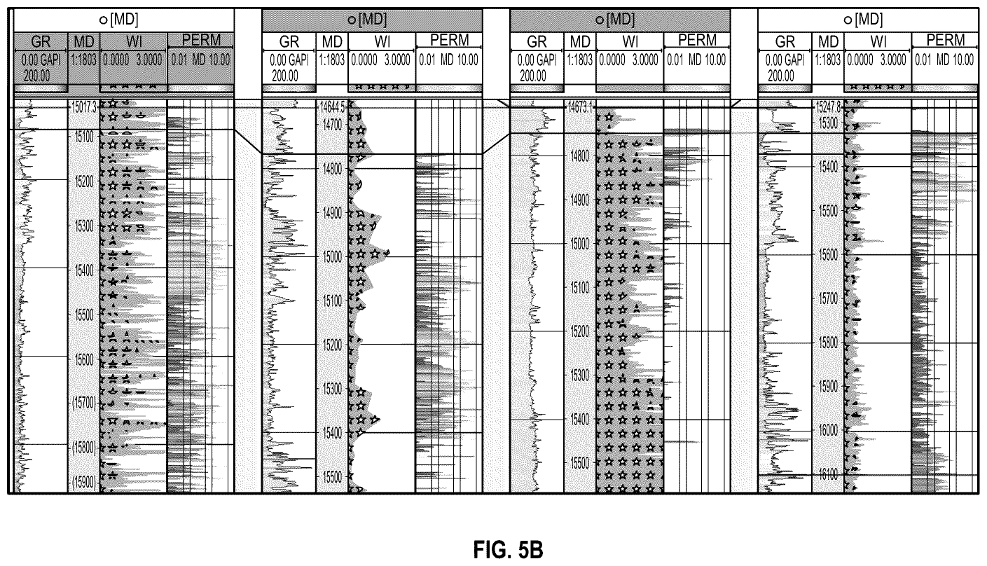

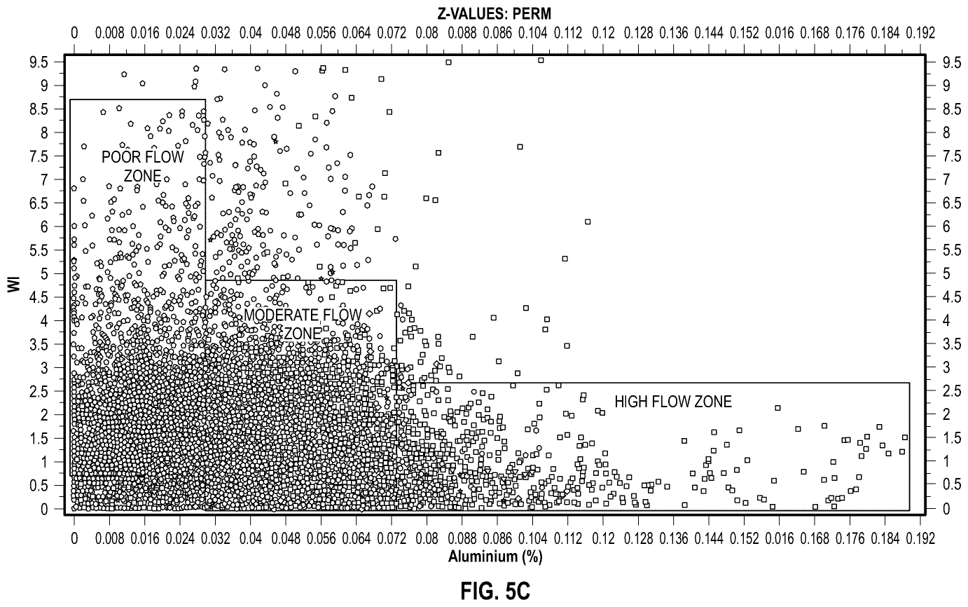

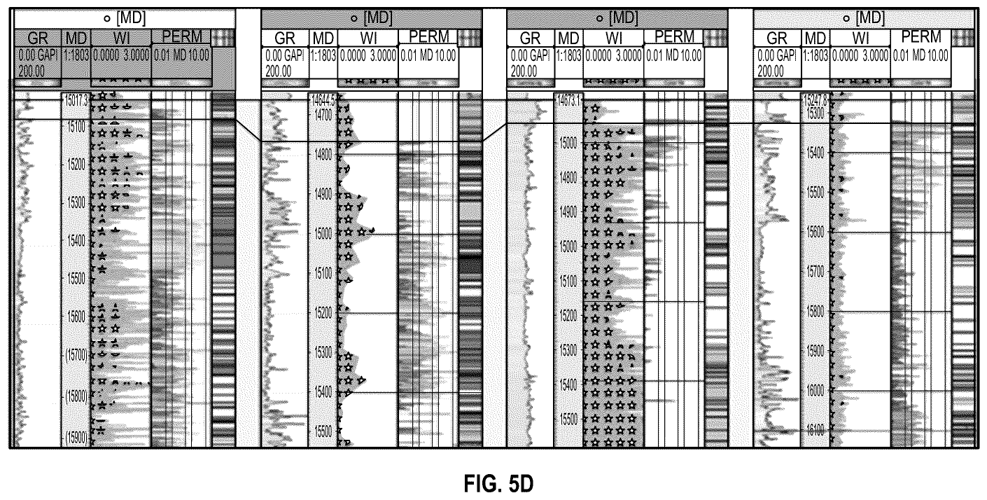

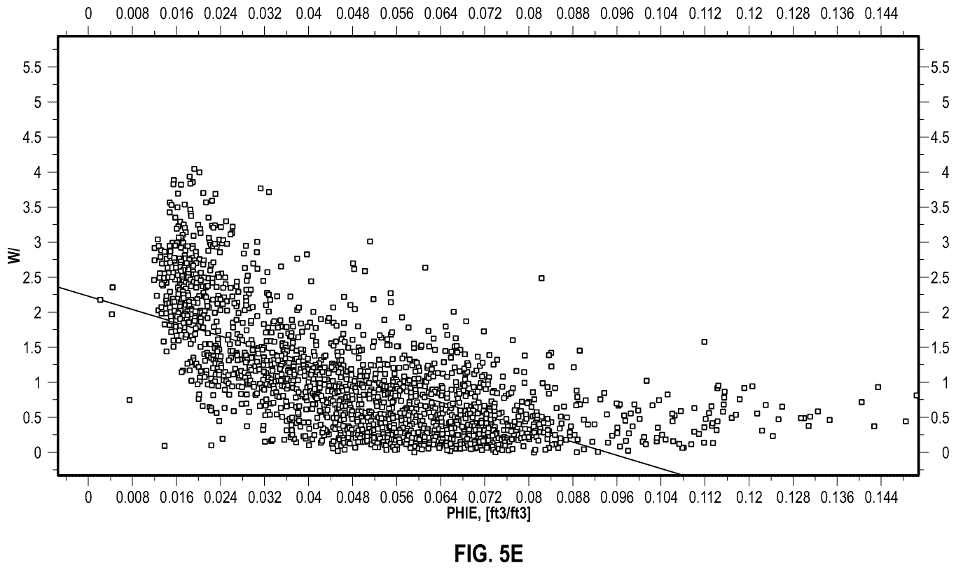

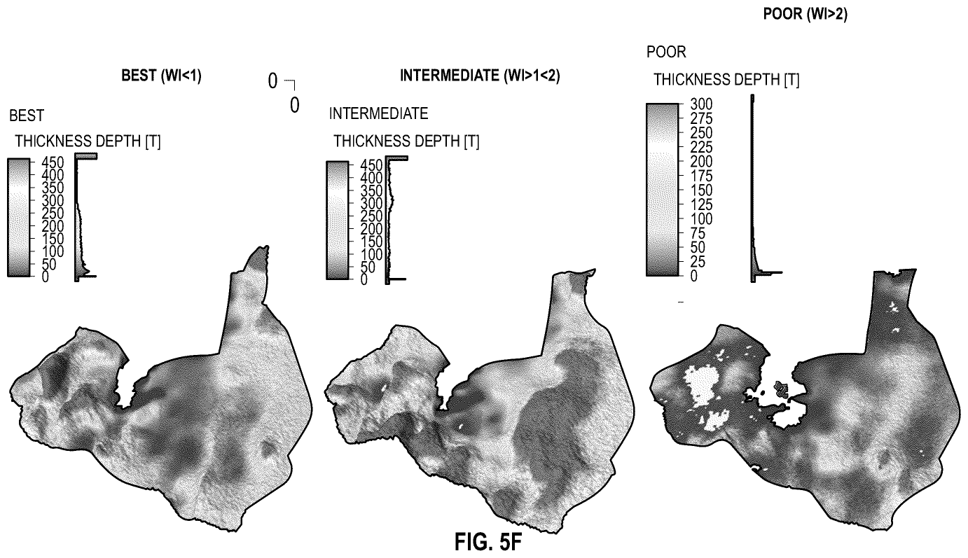

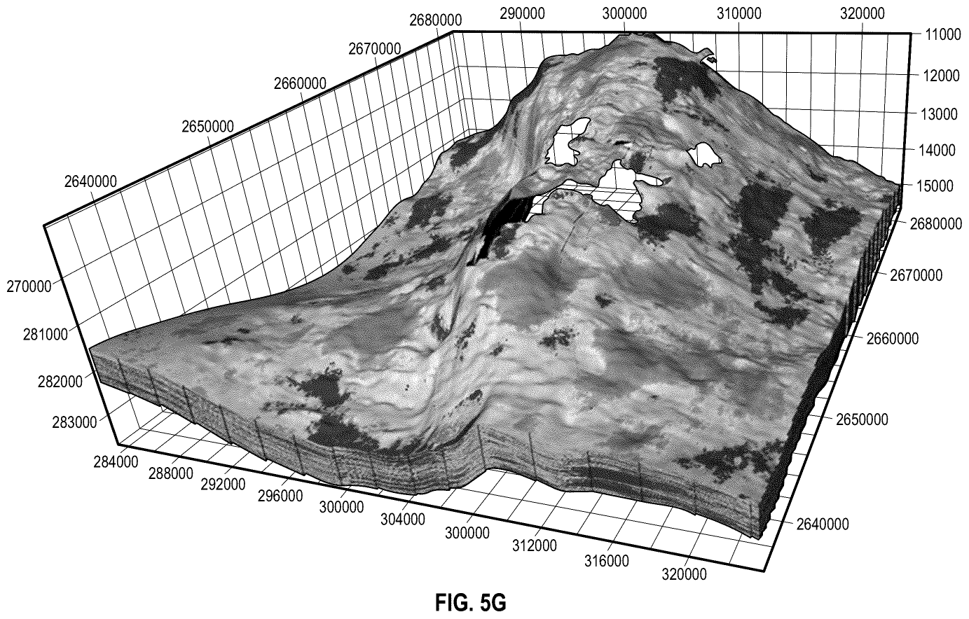

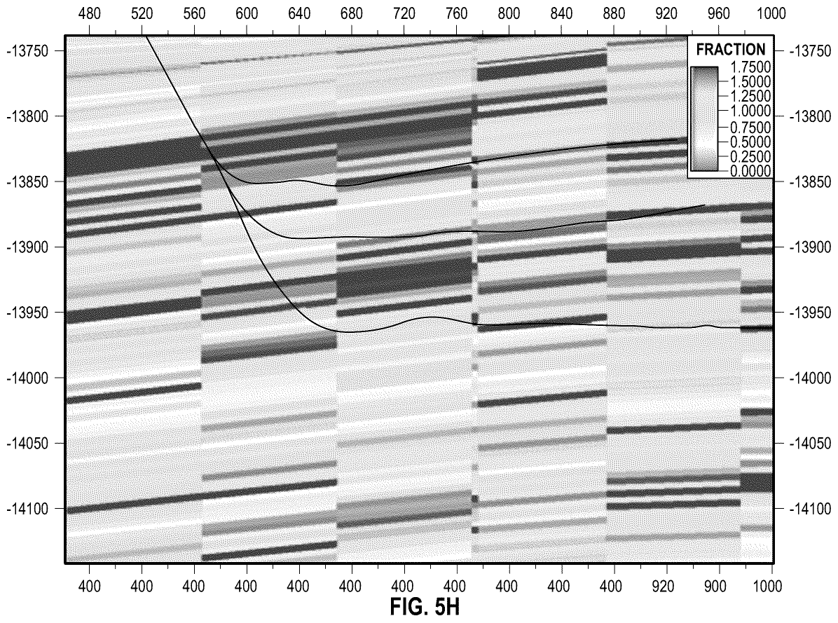

Turning to FIGS. 5A-5H, FIG. 5A illustrates a cross-plot showing a relation between potassium and aluminum with respect to effective porosity (PHIE). In FIG. 5A, a relation is shown between potassium and aluminum constituents that is used to defined three hydrocarbon zones (i.e., a “best” zone, an “intermediate” zone, and a “poor” zone). Different locations in each hydrocarbon zone have various effective porosity (PHIE) values, where PHIE decreases with increasing potassium and aluminum. PHIe may also increases with decreasing potassium and aluminum. The “best” zone may have elemental ratio values that are less than one, and thus require no hydraulic fracturing for producing gas in commercial quantities and is suitable for an under balanced coiled tubing unit. The “intermediate” zone may include weathering index data with elemental ratio values that are more than one but less than 2.5, which may require hydraulic fracturing to get commercial production of hydrocarbons. In the “poor” zone, the chemical ratio values are above 2.5.

Turning to FIG. 5B, FIG. 5B shows various weathering index logs that are generated in profile form based of Equation 1 above and are plotted alongside a gamma ray (GR) log and a permeability log for a common depth interval. FIG. 5B is an example log comparison for checking variation in geological properties in the same reservoir. In a particular profile, track 1 shows gamma ray logging data, track 2 shows weathering index data, and track 3 shows permeability data. FIG. 5B further shows that with the same gamma ray range, permeability may vary with corresponding variations of weathering index values.

Turning to FIG. 5C, FIG. 5C showing an example of hydrocarbon zonation based on effective porosity, weathering index values, and permeability in accordance with one or more embodiments. Here, a clear hydrocarbon zonation is shown based on these three parameters that distinguish zones of free reservoir flow to zones which need stimulation, and further zones of no reservoir fluid flow. As such, FIG. 5C illustrates hydrocarbon zones with variable flow character, and delineating these hydrocarbon zones may lead to improved well placement and completion strategies.

In FIG. 5D, FIG. 5D shows a zone log based on various weathering index cutoffs or thresholds shown in FIG. 5C. The zone log illustrates variations in reservoir properties based on porosity and weathering index data. Consequently, these profiles may be used to identify hydrocarbon zones of high flow, flow with stimulation and zones with little or no flow.

In FIG. 5E, FIG. 5E shows a relation between weathering index data and effective porosity, where a decrease in porosity occurs with increasing weathering index values. In particular, a negative coefficient of 66% was determined based on a linear trend, where the coefficient is used for populating weathering index values by statistically using a PHIE volume as secondary variable. As such, PHIE values and weathering index values are used to generate a function to determine correlation coefficients to guide co-kriging of a secondary reservoir property. In FIG. 5F, FIG. 5F shows different rock type thicknesses identified in a reservoir based on a weathering index cutoff. FIG. 5G shows a 3D distributed WI on field scale that shows good zones with higher flow potential. Likewise, FIG. 5H shows a cross section view of weathering index data along a well profile.

In Block 430, a well path is determined in a geological region of interest using one or more hydrocarbon zones and weathering index data in accordance with one or more embodiments. For example, a well path may be determined as described above in FIGS. 1, 2A, and 2B, and the accompanying description.

In Block 440, one or more stimulation operations are determined for a geological region of interest based on weathering index data, one or more hydrocarbon zones, and/or a well path in accordance with one or more embodiments. Based on weathering index values, stimulation parameters relating to fracturing fluid, injection rate, injection consequence, etc. may be determined for a hydraulic fracturing operation or other stimulation operation. For example, a stimulation operation may be determined and/or implemented as described above in FIG. 3 and the accompanying description.

In Block 450, one or more commands are transmitted to one or more control systems based on a well path and one or more stimulation operations in accordance with one or more embodiments. For example, commands may be transmitted to various control system to automate drilling operations or stimulation operations necessary for drilling or completing a well. Likewise, a user may select different stimulation parameters or adjusted drilling parameters based on predicted hydrocarbon data. A user selection may be obtained within a graphical user interface.

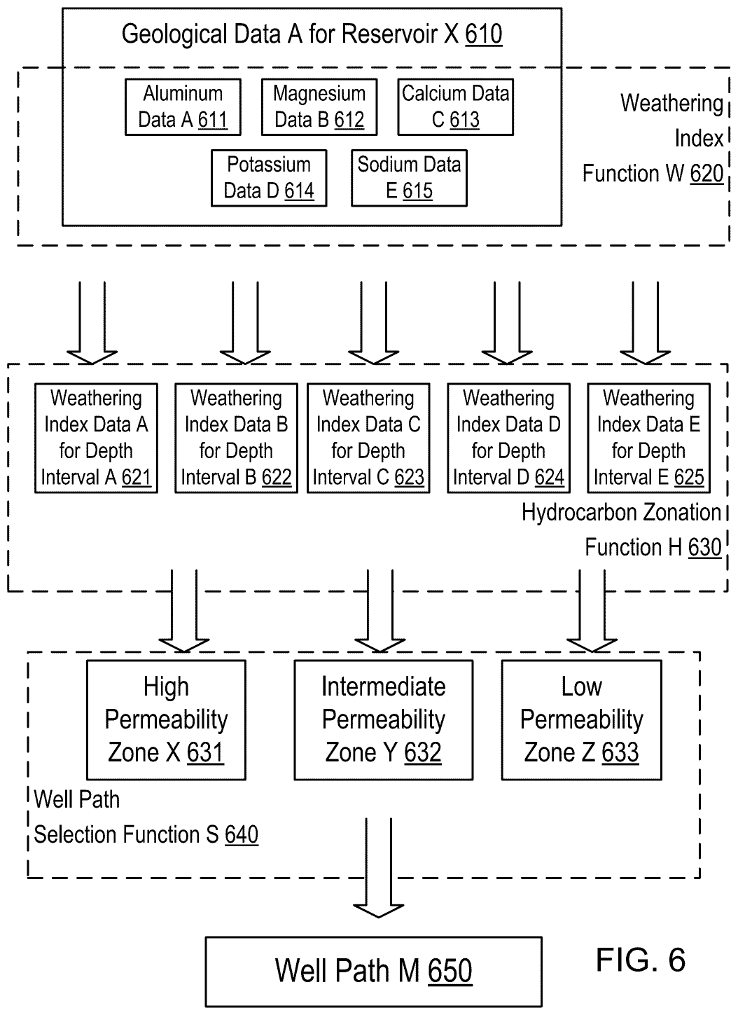

Turning to FIG. 6, FIG. 6 shows an example of determining a well path using weathering index data in accordance with one or more embodiments. In FIG. 6, a reservoir simulator (not shown) obtains geological data A (610) for a reservoir X, where the geological data A (610) includes aluminum data A (611), magnesium data B (612), calcium data C (613), potassium data D (614), and sodium data E (615) regarding portions of reservoir X. In particular, the reservoir simulator applies a weathering index function W (620) to the elemental data (i.e., aluminum data A (611), magnesium data B (612), calcium data C (613), potassium data D (614), and sodium data E (615)) to determine weathering index data at different locations (i.e., weathering index data A (621) for depth interval A, weathering index data B (622) for depth interval B, weathering index data C (623) for depth interval C, weathering index data D (624) for depth interval D, and weathering index data E (625) for depth interval E). Using the weathering index data (621, 622, 623, 624, 625), the reservoir simulator determines various hydrocarbon zones, i.e., high permeability zone X (631), intermediate permeability zone Y (632), and low permeability zone Z (633) based on a hydrocarbon zonation function H (630). Finally, the reservoir simulator analyzes the different hydrocarbon zones (631, 632, 633) with a well path selection function S (640) to determine a well path M (650) that is the best option for recovering hydrocarbons from reservoir X, i.e., located at high permeability zone X (631).

Embodiments may be implemented on a computer system. FIG. 7 is a block diagram of a computer system (702) used to provide computational functionalities associated with described algorithms, methods, functions, processes, flows, and procedures as described in the instant disclosure, according to an implementation. The illustrated computer (702) is intended to encompass any computing device such as a high performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (702) may include a computer that includes an input device, such as a keypad, keyboard, touch screen, or other device that can accept user information, and an output device that conveys information associated with the operation of the computer (702), including digital data, visual, or audio information (or a combination of information), or a GUI.

The computer (702) can serve in a role as a client, network component, a server, a database or other persistency, or any other component (or a combination of roles) of a computer system for performing the subject matter described in the instant disclosure. The illustrated computer (702) is communicably coupled with a network (730) or cloud. In some implementations, one or more components of the computer (702) may be configured to operate within environments, including cloud-computing-based, local, global, or other environment (or a combination of environments).

At a high level, the computer (702) is an electronic computing device operable to receive, transmit, process, store, or manage data and information associated with the described subject matter. According to some implementations, the computer (702) may also include or be communicably coupled with an application server, e-mail server, web server, caching server, streaming data server, business intelligence (BI) server, or other server (or a combination of servers).

The computer (702) can receive requests over network (730) or cloud from a client application (for example, executing on another computer (702)) and responding to the received requests by processing the said requests in an appropriate software application. In addition, requests may also be sent to the computer (702) from internal users (for example, from a command console or by other appropriate access method), external or third-parties, other automated applications, as well as any other appropriate entities, individuals, systems, or computers.

Each of the components of the computer (702) can communicate using a system bus (703). In some implementations, any or all of the components of the computer (702), both hardware or software (or a combination of hardware and software), may interface with each other or the interface (704) (or a combination of both) over the system bus (703) using an application programming interface (API) (712) or a service layer (713) (or a combination of the API (712) and service layer (713). The API (712) may include specifications for routines, data structures, and object classes. The API (712) may be either computer-language independent or dependent and refer to a complete interface, a single function, or even a set of APIs. The service layer (713) provides software services to the computer (702) or other components (whether or not illustrated) that are communicably coupled to the computer (702). The functionality of the computer (702) may be accessible for all service consumers using this service layer. Software services, such as those provided by the service layer (713), provide reusable, defined business functionalities through a defined interface. For example, the interface may be software written in JAVA, C++, or other suitable language providing data in extensible markup language (XML) format or other suitable format. While illustrated as an integrated component of the computer (702), alternative implementations may illustrate the API (712) or the service layer (713) as stand-alone components in relation to other components of the computer (702) or other components (whether or not illustrated) that are communicably coupled to the computer (702). Moreover, any or all parts of the API (712) or the service layer (713) may be implemented as child or sub-modules of another software module, enterprise application, or hardware module without departing from the scope of this disclosure.

The computer (702) includes an interface (704). Although illustrated as a single interface (704) in FIG. 7, two or more interfaces (704) may be used according to particular needs, desires, or particular implementations of the computer (702). The interface (704) is used by the computer (702) for communicating with other systems in a distributed environment that are connected to the network (730). Generally, the interface (704 includes logic encoded in software or hardware (or a combination of software and hardware) and operable to communicate with the network (730) or cloud. More specifically, the interface (704) may include software supporting one or more communication protocols associated with communications such that the network (730) or interface's hardware is operable to communicate physical signals within and outside of the illustrated computer (702).

The computer (702) includes at least one computer processor (705). Although illustrated as a single computer processor (705) in FIG. 7, two or more processors may be used according to particular needs, desires, or particular implementations of the computer (702). Generally, the computer processor (705) executes instructions and manipulates data to perform the operations of the computer (702) and any algorithms, methods, functions, processes, flows, and procedures as described in the instant disclosure.

The computer (702) also includes a memory (706) that holds data for the computer (702) or other components (or a combination of both) that can be connected to the network (730). For example, memory (706) can be a database storing data consistent with this disclosure. Although illustrated as a single memory (706) in FIG. 7, two or more memories may be used according to particular needs, desires, or particular implementations of the computer (702) and the described functionality. While memory (706) is illustrated as an integral component of the computer (702), in alternative implementations, memory (706) can be external to the computer (702).

The application (707) is an algorithmic software engine providing functionality according to particular needs, desires, or particular implementations of the computer (702), particularly with respect to functionality described in this disclosure. For example, application (707) can serve as one or more components, modules, applications, etc. Further, although illustrated as a single application (707), the application (707) may be implemented as multiple applications (707) on the computer (702). In addition, although illustrated as integral to the computer (702), in alternative implementations, the application (707) can be external to the computer (702).

There may be any number of computers (702) associated with, or external to, a computer system containing computer (702), each computer (702) communicating over network (730). Further, the term “client,” “user,” and other appropriate terminology may be used interchangeably as appropriate without departing from the scope of this disclosure. Moreover, this disclosure contemplates that many users may use one computer (702), or that one user may use multiple computers (702).

In some embodiments, the computer (702) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, a cloud computing system may operate according to one or more service models, such as infrastructure as a service (IaaS), platform as a service (PaaS), software as a service (SaaS), mobile “backend” as a service (MBaaS), artificial intelligence as a service (AlaaS), serverless computing, and/or function as a service (FaaS).

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method, comprising:
obtaining geological data for a geological region of interest, wherein the geological data comprises aluminum (Al) data;
determining, by a computer processor, weathering index data for the geological region of interest using the geological data, wherein the weathering index data describes alterations of detrital minerals to authigenic clay minerals;
determining, by the computer processor, a plurality of hydrocarbon zones in the geological region of interest using the weathering index data;
determining, by the computer processor, a well path in the geological region of interest based on the plurality of hydrocarbon zones; and
transmitting, by the computer processor, a first command to a first drilling system based on the well path.

2. The method of claim 1, further comprising:
determining a sweet spot within the geological region of interest using the weathering index data;
determining one or more stimulation parameters for a stimulation operation at the sweet spot using the weathering index data; and
transmitting, to a stimulation control system, a second command configured to perform the stimulation operation based on the one or more stimulation parameters.

3. The method of claim 1, further comprising:
determining a plurality of elemental logs from one or more wellbores using a plurality of cuttings and an X-ray fluorescence (XRF) spectrometer,
wherein a portion of the geological data is based on the plurality of elemental logs.

4. The method of claim 1, further comprising:
determining effective porosity data of a plurality of regions in the geological region of interest,
wherein the plurality of hydrocarbon zones are determined using the effective porosity data and the weathering index data.

5. The method of claim 1,
wherein the geological data further comprises magnesium (Mg) data, calcium data (Ca), potassium (K) data, and sodium (Na) data, and
wherein the weathering index data is based on an elemental ratio of aluminum to a sum of magnesium, calcium, potassium, and sodium at a predetermined depth interval.

6. The method of claim 1,
wherein the weathering index data describes changes of magnesium, potassium, and sodium with respect to aluminum among a plurality of grains in the geological region of interest.

7. The method of claim 1, further comprising:
performing a drilling operation at a wellbore in the geological region of interest,
wherein the drilling operation acquires a plurality of cuttings from drilling fluid circulated in the wellbore during the drilling operation; and
determining cutting data from the plurality of cuttings,
wherein a portion of the geological data is based on the cutting data.

8. The method of claim 1, further comprising:
acquiring, using a coring tool, one or more core samples from a wellbore in the geological region of interest; and
determining core sample data using the one or more core samples,
wherein a portion of the geological data is based on the core sample data.

9. The method of claim 1, further comprising:
obtaining a plurality of well logs for a plurality of wells in the geological region of interest, and
wherein a portion of the geological data is based on the plurality of well logs.

10. The method of claim 1,
wherein the plurality of hydrocarbon zones correspond to a first weathering index threshold, a second weathering index threshold, and a third weathering index threshold,
wherein the first weathering index threshold corresponding to a predetermined amount of hydrocarbon recoverable without a stimulation operation,
wherein the second weathering index threshold corresponding to a predetermined amount of hydrocarbon that is recoverable only with a stimulation operation, and
wherein the third weathering index threshold corresponding to no amount of hydrocarbon recoverable with a stimulation operation.

11. The method of claim 1,
wherein the plurality of hydrocarbon zones comprises a first hydrocarbon zone and a second hydrocarbon zone,
wherein the first hydrocarbon zone corresponds to a first portion of the geological region of interest comprising a first permeability threshold, and
wherein the second hydrocarbon zone corresponds to a second portion of the geological region of interesting comprising a second permeability threshold that is different from the first permeability threshold.

12. A system, comprising:
a stimulation control system coupled to a wellbore; and
a reservoir simulator coupled to the stimulation control system, wherein the reservoir simulator comprises a computer processor, the reservoir simulator is configured to perform a method comprising:
obtaining geological data for a geological region of interest, wherein the geological data comprises aluminum (Al) data;
determining weathering index data for the geological region of interest using the geological data, wherein the weathering index data describes alterations of detrital minerals to authigenic clay minerals; and
determining a plurality of stimulation parameters based on the weathering index data,
wherein the stimulation control system is configured to perform a hydraulic stimulation operation based on the plurality of stimulation parameters.

13. The system of claim 12, further comprising:
a user device coupled to the stimulation control system,
wherein the user device is configured to provide a graphical user interface for presenting the plurality of stimulation parameters.

14. The system of claim 12,
wherein the geological data further comprises magnesium (Mg) data, calcium data (Ca), potassium (K) data, and sodium (Na) data, and
wherein the weathering index data is based on an elemental ratio of aluminum to a sum of magnesium, calcium, potassium, and sodium at a predetermined depth interval.

15. The system of claim 12, further comprising:
a logging system comprising a coring tool,
wherein one or more core samples are acquired from a wellbore in the geological region of interest using the coring tool,
wherein a portion of the geological data is based on core sample data using the one or more core samples.

16. The system of claim 12,
wherein a portion of the geological data is based on a plurality of elemental logs for one or more wellbores, and
wherein the plurality of elemental logs are determined using a plurality of cuttings and an X-ray fluorescence (XRF) spectrometer.

17. A system, comprising:
a drilling system comprising a plurality of sensors and a drill string comprising a drill bit, wherein the drilling system is coupled to a wellbore; and
a reservoir simulator coupled to the drilling system, wherein the reservoir simulator comprises a computer processor, the reservoir simulator is configured to perform a method comprising:
obtaining geological data for a geological region of interest, wherein the geological data comprises aluminum (Al) data;
determining weathering index data for the geological region of interest using the geological data, wherein the weathering index data describes alterations of detrital minerals to authigenic clay minerals;
determining a plurality of hydrocarbon zones in the geological region of interest using the weathering index data; and
determining a well path in the geological region of interest based on the plurality of hydrocarbon zones,
wherein the drilling system is configured to perform a drilling operation for a well path based on the plurality of hydrocarbon zones.

18. The system of claim 17,
wherein the geological data further comprises magnesium (Mg) data, calcium data (Ca), potassium (K) data, and sodium (Na) data, and
wherein the weathering index data is based on an elemental ratio of aluminum to a sum of magnesium, calcium, potassium, and sodium at a predetermined depth interval.

19. The system of claim 17,
wherein a portion of the geological data is based on a plurality of elemental logs for one or more wellbores, and
wherein the plurality of elemental logs are determined using a plurality of cuttings and an X-ray fluorescence (XRF) spectrometer.

20. The system of claim 17, further comprising:
a logging system comprising a coring tool,
wherein one or more core samples are acquired from a wellbore in the geological region of interest using the coring tool,
wherein a portion of the geological data is based on core sample data using the one or more core samples.
